(19) United States
(12) Patent Application Publication
(10) Pub. No.: US 2016/0027018 A1
(43) Pub. Date: Jan. 28, 2016

(54) MATCHING RESOURCES TO AN OPPORTUNITY IN A CUSTOMER RELATIONSHIP MANAGEMENT (CRM) SYSTEM

(71) Applicant: International Business Machines Corporation, Armonk, NY (US)

(72) Inventors: Barry R. Beggs, JR., Chapel Hill, NC (US); Feng-Wei Chen, Cary, NC (US); Brett Gavagni, Coconut Creek, FL (US); David G. George, Cary, NC (US); Luciano Silva, Apex, NC (US)

(73) Assignee: INTERNATIONAL BUSINESS MACHINES CORPORATION, Armonk, NY (US)

(21) Appl. No.: 14/645,186

(22) Filed: Mar. 11, 2015

Related U.S. Application Data
(63) Continuation of application No. 14/444,490, filed on Jul. 28, 2014.

(51) Int. Cl. G06Q 30/00; G06Q 10/06

(52) U.S. Cl. CPC G06Q 30/01; G06Q 10/063112

(57) ABSTRACT

Matching resources to an opportunity in a customer relationship management (CRM) system includes obtaining, from a CRM system, an opportunity, the opportunity representing a complex record structure in the CRM system, in which the opportunity captures a number of fields of metadata, determining, from the metadata, a number of opportunity attributes associated with the opportunity, determining a number of resource attributes for a number of resources, ranking the resource attributes with the opportunity attributes to determine a score for each of the resources, and presenting, based on the score, a list of the resources that are recommended for the opportunity.

### BACKGROUND

The present invention relates to matching resources to an opportunity, and more specifically, to matching resources to an opportunity in a customer relationship management (CRM) system.

A CRM system uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

### BRIEF SUMMARY

A method for matching resources to an opportunity in a customer relationship management (CRM) system includes obtaining, from a CRM system, an opportunity, the opportunity representing a complex record structure in the CRM system, in which the opportunity captures a number of fields of metadata, determining, from the metadata, a number of opportunity attributes associated with the opportunity, determining a number of resource attributes for a number of resources, ranking the resource attributes with the opportunity attributes to determine a score for each of the resources, and presenting, based on the score, a list of the resources that are recommended for the opportunity.

A system for matching resources to an opportunity in a CRM system includes an obtaining engine to obtain, from a CRM system, an opportunity, the opportunity representing a complex record structure in the CRM system, in which the opportunity captures a number of fields of metadata, an opportunity attribute determining engine to determine, from the metadata, a number of opportunity attributes associated with the opportunity, a resource attribute determining engine to determine a number of resource attributes for a number of resources, a ranking engine to rank the resource attributes with the opportunity attributes to determine a score for each of the resources, an applying engine to apply a weigh to the score, and a presenting engine to present, based on the score, a list of the resources that are recommended for the opportunity.

A computer program product includes a computer readable storage medium, the computer readable storage medium having computer readable program code embodied therewith. The computer readable program code having computer readable program code to determine, from metadata of an opportunity, a number of opportunity attributes associated with the opportunity, determine a number of resource attributes for a number of resources, rank the resource attributes with the opportunity attributes to determine a score for each of the resources, apply a weigh to the score, and present, based on the score, a list of the resources that are recommended for the opportunity.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for matching resources to an opportunity in a customer relationship management (CRM) system, according to one example of principles described herein.

FIG. 2 is a diagram of an example of a system for matching resources to an opportunity in a CRM system, according to one example of principles described herein.

FIG. 3 is an example of matching resources to an opportunity in a CRM system, according to one example of principles described herein.

FIG. 4 is a flowchart of an example of a method for matching resources to an opportunity in a CRM system, according to one example of principles described herein.

FIG. 5 is a flowchart of an example of a method for matching resources to an opportunity in a CRM system, according to one example of principles described herein.

FIG. 6 is a diagram of an example of a matching system, according to the principles described herein.

FIG. 7 is a diagram of an example of a matching system, according to the principles described herein.

Throughout the drawings, identical reference numbers designate similar, but not necessarily identical, elements.

### DETAILED DESCRIPTION

The present specification describes a method and system for matching resources to an opportunity in a customer relationship management (CRM) system, such that appropriate resources are recommended for an opportunity.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the CRM system uses techniques and methods to organize, automate, and synchronize sales, for marketing, customer service, and technical support. This information that the CRM system gathers is stored in the CRM system's memory. Further, this information may be categorized as opportunities in the CRM system's memory. A user associated with a company may view the opportunities gather by the CRM system to allow the company to better target various customers.

Often, opportunity owners of a CRM system are largely on their own in locating the appropriate resources, such as sellers or technical support, that are needed to advance an opportunity. In one example, an opportunity includes a series of products and/or services to satisfy a business gap of an opportunity for a client. Further, roles for the opportunity may include specific products and/or services owners for a brand such as hardware product, services offering, software product, among others as well as categories such as client financing. Further, this may apply to client level roles for an opportunity such as client representative that manages an overall client relationship. In one example, a CRM system uses a resource compensation system to determine which resources should be assigned to a given opportunity. However, the resource compensation system does not provide guidance for specific resources that are needed for products and/or services of the opportunity. As a result, the resource compensation system is not accurate in determining which resources are to be assigned to an opportunity.

Further, a user may manually determine which resources are to be assigned to an opportunity. This can be a burdensome task for a user when there are thousands of resources to match to thousands of opportunities.

The principles described herein include a system and a method for matching resources to an opportunity in a CRM system. Such a system and method includes obtaining, from a CRM system, an opportunity, the opportunity representing a complex record structure in the CRM system, in which the opportunity captures a number of fields of metadata, determining, from the metadata, a number of opportunity attributes associated with the opportunity, determining a number of resource attributes for a number of resources, ranking the resource attributes with the opportunity attributes to determine a score for each of the resources, and presenting, based on the score, a list of the resources that are recommended for the opportunity. Such a method and system allows the number of resources to be recommended for the opportunity based on the score. As a result, appropriate resources are recommended for the opportunity.

In the specification and appended claims, the term “opportunity attributes” is meant to be understood broadly as criteria for a specific sale that is associated with an opportunity. In one example, opportunity attributes may be derived from metadata associated with an opportunity in a CRM system. In one example, the opportunity attributes include a client, a location, an industry, a model of coverage by sales, a corporate structure for one of the opportunities, a sales stage, products, offerings, brands, revenue, client attributes, or combinations thereof. Further, in one example, the opportunity attributes may include client attributes. In one example, the client attributes describe characteristics of a client, such as a specific individual and/or organization, that is associated with the opportunity

In the specification and appended claims, the term “resource” is meant to be understood broadly a specific individual and/or organization that aids in the progression of an opportunity through selling products and/or services. In one example, a resource may be a seller, a sales team, tech support, other resources, or combinations thereof.

In the specification and appended claims, the term “resource attributes” is meant to be understood broadly as criteria for a specific individual and/or organization, such as a seller that aids in the progression of an opportunity through selling products and/or services. In one example, the resource attributes include an incentive, a territory, an expertise, or combinations thereof

In the specification and appended claims, the term “score” is meant to be understood broadly as a mechanism for ranking resource attributes with the opportunity attributes to determine how well resources match an opportunity. In one example, a score includes a motivation score, a proximity score, a skill score, or combinations thereof. Further, a score may be symbolic such as low, medium, or high. In this example, a score that is low indicates that a resource is not a good match for an opportunity. Alternatively, a score that is high indicates that a resource is a good match for an opportunity. Further, a score may be based on a scale, such as 0 to 10. In this example, a score of 0 indicates that a resource is not a good match for an opportunity. Alternatively, a score that is 10 indicates that a resource is a good match for an opportunity.

In the specification and appended claims, the term “opportunities” is meant to be understood broadly as a complex record structure in a CRM system, in which each of the opportunities captures a number of fields of metadata. In one example, the opportunities may include a business's sales and/or interaction with current customers, future customers, or combinations thereof. In one example, an opportunity may be a sales opportunity or a sales deal.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

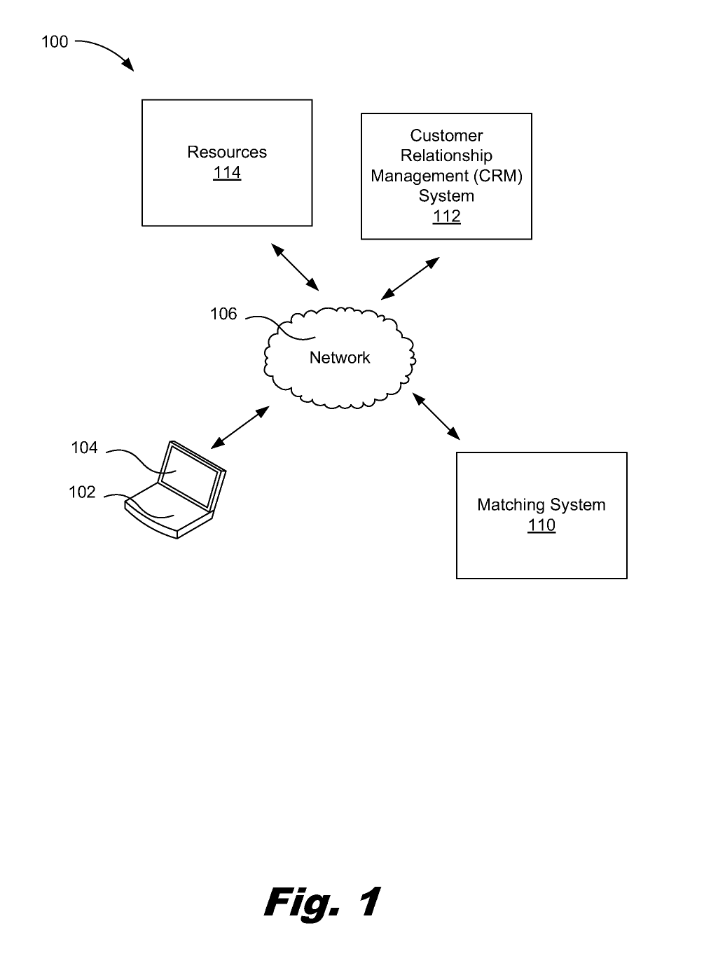

FIG. 1 is a diagram of an example of a system for matching resources to an opportunity in a CRM system, according to one example of principles described herein. As will be described below, a matching system is in communication with a network to obtain, from a CRM system, an opportunity, the opportunity representing a complex record structure in the CRM system, in which the opportunity captures a number of fields of metadata. The matching system determines, from the metadata, a number of opportunity attributes associated with the opportunity. Further, the matching system determines a number of resource attributes for a number of resources. The matching system further ranks the resource attributes with the opportunity attributes to determine a score for each of the resources. Further, the matching system presents, based on the score, a list of the resources that are recommended for the opportunity.

As illustrated in FIG. 1, the system (100) includes a CRM system (112). As mentioned above, the CRM system (112) uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

As illustrated in FIG. 1, the system (100) includes a number of resources (114). In this example, the resources (114) may be a specific individual and/or organization, such as a seller, that aids in the progression of an opportunity through selling products and/or services. As will be described in other parts of this specification, the resources (114) may be associated with resource attributes. The resource attributes may be specific criteria for the resources (114) that aids in the progression of an opportunity through selling products and/or services. In one example, the resource attributes include an incentive, a territory, an expertise, or combinations thereof.

As illustrated in FIG. 1, the system (100) includes a matching system (110). The matching system (110) is in communication with a network (106) to obtain, from the CRM system (112), an opportunity. In one example, the opportunity represents a complex record structure in the CRM system (112). Further, the opportunity captures a number of fields of metadata.

The matching system (110) determines, from the metadata, a number of opportunity attributes associated with the opportunity. In one example, the opportunity attributes include a client, a location, an industry, a model of coverage by sales, a corporate structure for one of the opportunities, a sales stage, products, offerings, brands, revenue, client attributes, or combinations thereof.

Further, the matching system (110) determines a number of resource attributes for the number of resources (114). As mentioned above, the resource attributes include an incentive, a territory, an expertise, or combinations thereof.

The matching system (110) further ranks the resource attributes with the opportunity attributes to determine a score for each of the resources (114). In one example, ranking the resource attributes with the opportunity attributes to determine the score for each of the resources (114) includes determining a threshold for the score. In this example, the resources (114) with the highest score may be matched to the opportunity automatically.

Further, the matching system (110) presents, based on the score, a list of the resources that are recommended for the opportunity. In one example, the list of the resources may be presented to a user via a display (104) of a user device (102). Such a system (100) allows a number of resources to be recommended for an opportunity based on a score. As a result, appropriate resources are recommended for an opportunity.

While this example has been described with reference to the matching system being located over the network, the matching system may be located in any appropriate location. For example, the matching system may be located in a user device, a database, a CRM system, other locations, or combinations thereof.

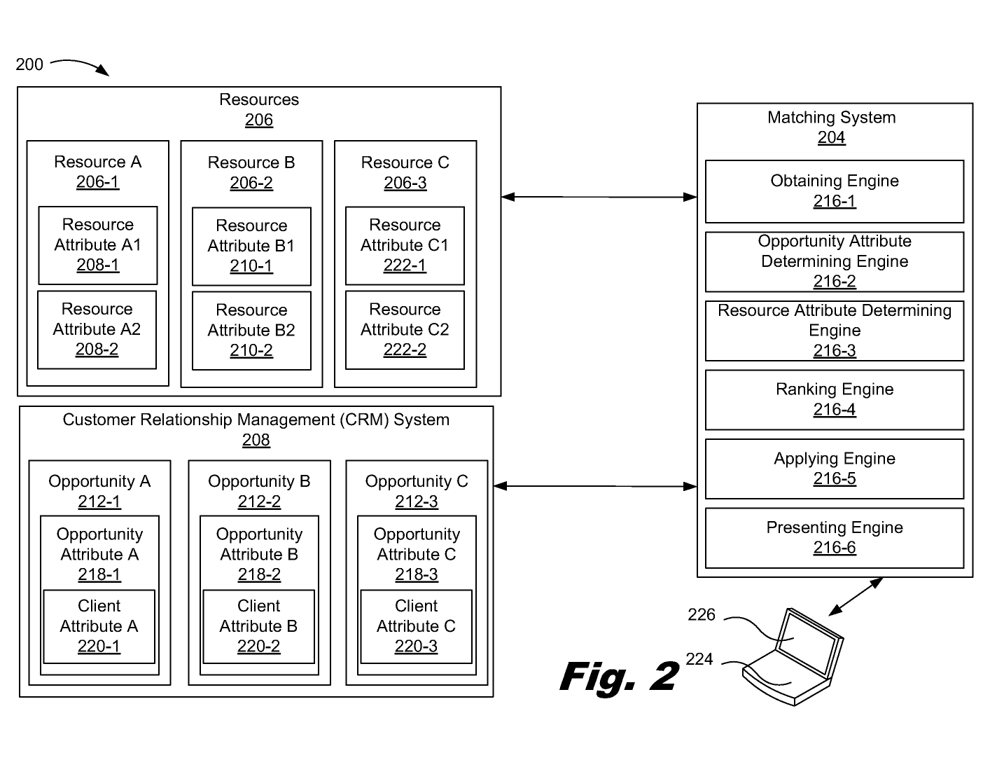

FIG. 2 is a diagram of an example of a system matching resources to an opportunity in a CRM system, according to one example of principles described herein. As mentioned above, a matching system is in communication with a network to obtain, from a CRM system, an opportunity, the opportunity representing a complex record structure in the CRM system, in which the opportunity captures a number of fields of metadata. The matching system determines, from the metadata, a number of opportunity attributes associated with the opportunity. Further, the matching system determines a number of resource attributes for a number of resources. The matching system further ranks the resource attributes with the opportunity attributes to determine a score for each of the resources. Further, the matching system presents, based on the score, a list of the resources that are recommended for the opportunity.

As illustrated in FIG. 2, the system (200) includes a CRM system (208). As mentioned above, the CRM system (208) is used as a model for managing a business's interactions with current and future customers. The CRM system (208) uses techniques and methods to organize, automate, and synchronize sales, for marketing, customer service, and technical support. In one example, the CRM system (208) may be a classical CRM system that monitors sources such as current customers and potentially future customers to gather information to better target various customers. The classical CRM system traditionally includes a one-way communication between a business and the customer.

In another example, the CRM system (208) may be a social CRM system that monitors sources such as social media sources. In this example, the social CRM system's strategy is based around customer engagement and interactions, with transactions being a byproduct. In one example, the Social CRM system may use a philosophy and a business strategy, supported by a technology platform, business rules, workflow, processes and social characteristics, designed to engage the customer in a collaborative conversation in order to provide mutually beneficial value in a trusted and transparent business environment. Further, the social CRM system includes applications in marketing, customer service and sales, including peer-to-peer customer support, idea management, market research, product launch, brand reputation management.

In this example, the social CRM system is a back-end process and system for managing customer relationships and data in an efficient and process-centric way. The social CRM system is able to understand the business's challenges that are to be solved and then solve the business's challenges. Further, the social CRM system may be one component of developing a social or collaborative business, both internally and externally.

Regardless of if the CRM system (208) is a classical CRM system or a social CRM system, they are used to gather information about opportunities and populate the CRM system (208) with the information gathered about the opportunities. As illustrated, the CRM system (208) includes a number of opportunities (212). For example, the CRM system (208) includes opportunity A (212-1), opportunity B (212-2), and opportunity C (212-3). As mentioned above, the opportunities (212) may be a complex record structure in the CRM system (208), in which each of the opportunities (212) captures a number of fields of metadata. In one example, the opportunities (212) may include a business's sales and/or interaction with current customers, future customers, or combinations thereof. As illustrated, each of the opportunities (212) may be associated with a client attribute (218). For example, opportunity A (212-1) is associated with opportunity attribute A (218-1). Opportunity B (212-2) is associated with opportunity attribute B (218-2). Opportunity C (212-3) is associated with opportunity attribute C (218-3). As will be described below, the opportunity attributes (218) may include a client attribute (220) and its associated data such. In one example, the opportunity attributes (218) may include as a location, an industry, a model of coverage by sales, a corporate structure and opportunity specific information such a sales stage, products, offerings, brands, revenue, or combinations thereof. For example, client attribute A (220-1) may be associated with opportunity attribute A (218-1). Client attribute B (220-2) may be associated with opportunity attribute B (218-2). Further, client attribute C (220-3) may be associated with opportunity attribute C (218-3). In this example, the opportunity attributes (218) may be derived from the metadata associated with the opportunities (212).

As illustrated in FIG. 2, the system (200) includes a number of resources (206). In this example, the resources (206) may be a specific individual and/or organization that aids in the progression of an opportunity through selling products and/or services. In this example, the resources (206) include resource A (206-1), resource B (206-2), and resource C (206-3). Further, the resources (206) may have resource attributes (208, 210, 222). The resource attributes (208, 210, 222) may be criteria for the resources (206) that aids in the progression of an opportunity through selling products and/or services. In one example, the resource attributes (208, 210, 222) include an incentive, a territory, an expertise, or combinations thereof. As illustrated in FIG. 2, resource A (206-1) includes resource attribute A1 (208-1) and resource attribute A2 (208-2). Resource B (206-2) includes resource attribute B1 (210-1) and resource attribute B2 (210-2). Resource C (206-3) includes resource attribute C1 (222-1) and resource attribute C2 (222-2).

As illustrated in FIG. 1, the system (200) includes a matching system (204). In one example, the matching system (204) includes a number of engines (216). The engines (216) refer to a combination of hardware and program instructions to perform a designated function. Each of the engines (216) may include a processor and memory. The program instructions are stored in the memory and cause the processor to execute the designated function of the engine. In this example, the matching system (204) includes an obtaining engine (216-1), a opportunity attribute determining engine (216-2), a resource attribute determining engine (216-3), a ranking engine (216-4), an applying engine (216-5), and a presenting engine (216-6).

As mentioned above, the matching system (204) includes an obtaining engine (216-1). In one example, the obtaining (216-1) obtains, from the CRM system (208), an opportunity (212). For example, the obtaining (216-1) obtains, from the CRM system (208), opportunity A (212-1).

The matching system (110) includes the opportunity attribute determining engine (216-2). The opportunity attribute determining engine (216-2) determines, from the metadata, a number of opportunity attributes associated with the opportunity. For example, the opportunity attribute determining engine (216-2) determines, from the metadata, opportunity attribute A (218-1) is associated with opportunity A (212-1). In this example, opportunity attributes A (218-1) includes a client, a location, an industry, a model of coverage by sales, a corporate structure for one of the opportunities, a sales stage, products, offerings, brands, revenue, client attribute A (220-1), or combinations thereof for opportunity A (212-1).

Further, the matching system (204) includes the resource attribute determining engine (216-3). The resource attribute determining engine (216-3) determines the number of resource attributes (208, 210, 222) for the number of resources (206). For example, the resource attribute determining engine (216-3) determines resource attribute A1 (208-1) and resource attribute A2 (208-2) for resource A (206-1). In this example, resource attribute A1 (208-1) may be an incentive such as a direct quota and resource attribute A2 (208-2) may be a territory such as a specific country.

Further, the resource attribute determining engine (216-3) determines resource attribute B1 (210-1) and resource attribute B2 (210-2) for resource B (206-2). In this example, resource attribute B1 (210-1) may be an incentive such as a shared quota and resource attribute B2 (210-2) may be an expertise such as a specific product.

Further, the resource attribute determining engine (216-3) determines resource attribute C1 (222-1) and resource attribute C2 (222-2) for resource C (206-3). In this example, resource attribute C1 (222-1) may be an incentive such as a no quota and resource attribute C2 (210-2) may be an expertise such as a specific role.

The matching system (204) includes the ranking engine (216-4). The ranking engine (216-4) ranks the resource attributes (208, 210, 222) with the opportunity attributes (218) to determine a score for each of the resources, in this example, opportunity attribute A (218-1). As mentioned above, the score includes a motivation score, a proximity score, a skill score, or combinations thereof. For example, the ranking engine (216-4) ranks the resource attribute A1 (208-1) and resource attribute B1 (208-2) with the opportunity attribute A (218-1) to determine a motivation score for resource A (206-1). In this example, the motivation score for resource A (206-1) may be low. Similarly, the ranking engine (216-4) ranks the resource attribute A1 (208-1) and resource attribute A2 (208-2) with the opportunity attribute A (218-1) to determine a proximity score for resource A (206-1). In this example, the proximity score for resource A (206-1) may be medium. Similarly, the ranking engine (216-4) ranks the resource attribute A1 (208-1) and resource attribute A1 (208-2) with the opportunity attribute A (218-1) to determine a skill score for resource A (206-1). In this example, the skill score for resource A (206-1) may be medium.

Similarly, the ranking engine (216-4) ranks the resource attribute (210 and 222) with the opportunity attribute A (218-1) to determine a score for resource B (206-2) and resource C (206-3). In this example, the motivation, proximity, and skill, score for resource B (206-2) may be medium. Further, in this example, the motivation, proximity, and skill, score for resource B (206-2) may be medium. Further, in this example, the motivation score, proximity score, and skill score for resource C (206-2) may be high.

In one example, the ranking engine (216-4) ranks the resource attributes (208, 210, 222) with the opportunity attributes (218), to determine the score for each of the resources, in this example, opportunity attribute A (218-1), by further determining a threshold for the score. For example, the motivation score, proximity score, and skill score for the resources (206) are to exceed a motivation score of medium, a proximity score of medium, and skill score of medium for the ranking engine (216-4) to rank the resource attributes (208, 210, 222) with opportunity attribute A (218-1). As a result, the ranking engine (216-4) ranks the resource attributes (210, 222) associated with resource B (206-2) and resource C (206-3).

The matching system (204) further includes the applying engine (216-5). The applying engine (216-5) applies a weigh to the score. For example, if a user is interested in resources with a high motivation score, the applying engine (216-5) applies a weigh to the motivation score. As will be described below, the applying engine (216-5) may be used to allow a user to refine a list of the resources that are recommended for the opportunity. In this example, the user does not apply a weight the score.

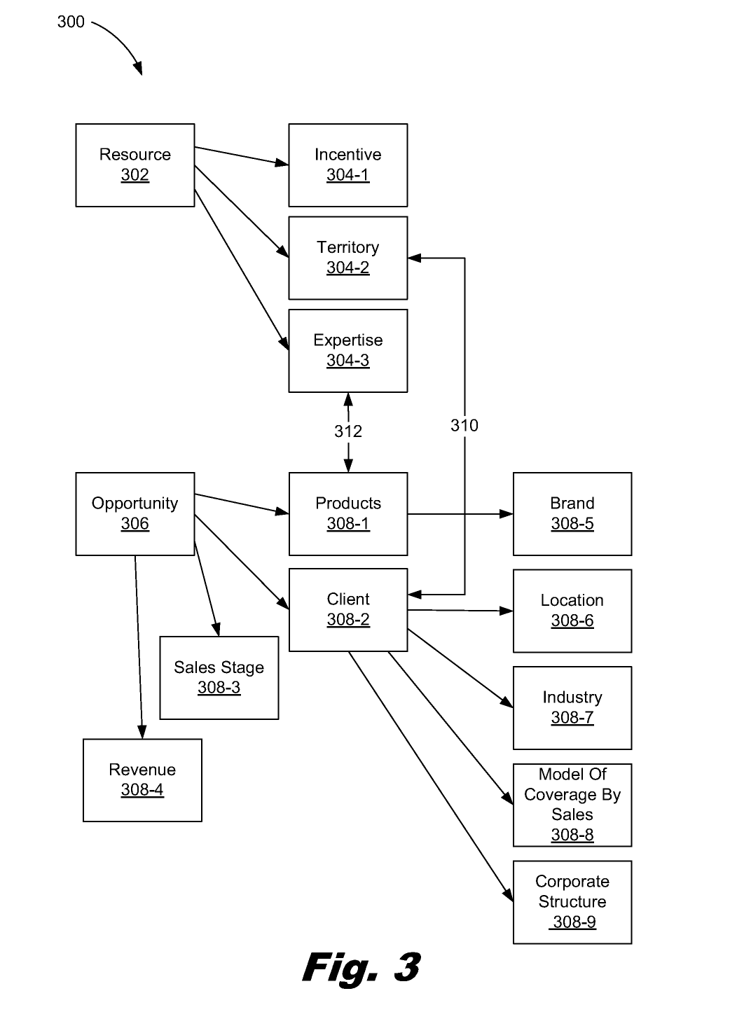

Further, the matching system (204) presents, based on the score, a list of the resources that are recommended for the opportunity. In keeping with the given example, resource B (206-2) and resource C (206-3) include scores that exceeded the threshold as described above. As a result, resource B (206-2) and resource C (206-3) are recommended for the opportunity. In one example, the resources may be prioritized and presented based on the score for each of the resources. For example, since resource C (206-3) had the highest score, resource C (206-3) is prioritized and presented before resource B (206-3). As mentioned above, the list may be presented to the user via a display (226) of a user device (224). Such a system (200) allows a number of resources to be recommended for an opportunity based on a score. As a result, appropriate resources are recommended for an opportunity. An overall example of matching resources to an opportunity will be described in further detail in FIG. 3.

While this example has been described with reference to the matching system matching resources to opportunity A in the CRM system, the matching system may match resources to other opportunities in the CRM system. For example, the matching system may match resources to opportunity B or opportunity C in the CRM system.

FIG. 3 is an example of matching resources to an opportunity in a CRM system, according to one example of principles described herein. As mentioned above, an overall example of matching resources to an opportunity will be described in further detail in FIG. 3. As will be described below, resource attributes for a resource may be used to match the resource to an opportunity.

As illustrated in FIG. 3, the diagram (300) includes a resource (302). In one example, the resource (302) includes a number of resource attributes (304). In this example, the resource attributes (304) include an incentive (304-1), a territory (304-2), and an expertise (304-3).

In one example, the incentive (304-1) may be associated with a medium motivation score. In this example, the medium motivation score may indicate the resource (302) is paid based on performance of a group.

In this example, the territory (304-2) may be associated with a high proximity score. In this example, the high proximity score may indicate the resource (302) is assigned to a specific client.

Further, the expertise (304-3) may be associated with a high skill score. In this example, the high skill score may indicate the resource (302) is has specific brand expertise.

As illustrated in FIG. 3, the diagram (300) includes an opportunity (306). In this example, the opportunity (306) includes a number of opportunity attributes (308). In this example, the opportunity attributes (308) include products (308-1), a client (308-2), a sales stage (308-3), and revenue (308-4). Further, a brand (308-5) may be associated with the products (308-1). Still further, a location (308-6), an industry (308-7), a model of coverage by sales (308-8), and a corporate structure (308-9) for the opportunity (306) may be associated with the client (308-2). In one example, since the location (308-6), the industry (308-7), the model of coverage by sales (308-8), and the corporate structure (308-9) are associated with the client (308-2), they may be considered to be client attributes.

In one example, the matching system of FIG. 2 matches the resource (302) with the opportunity (306) as described above. In this example, the territory (304-2) may match the client (308-2) as indicated by arrow 310. In this example, the territory (304-2) may match the client (308-2) due to a high proximity score. Further, the expertise (304-3) may match the product (308-1) as indicated by arrow 312. In this example, the expertise (304-3) may match the product (308-1) due to a high skill score.

As mentioned above, the diagram (300) may be presented to the user via a display of a user device. In one example, the diagram (300) may be presented to the user as a list of the resources that are recommended for the opportunity.

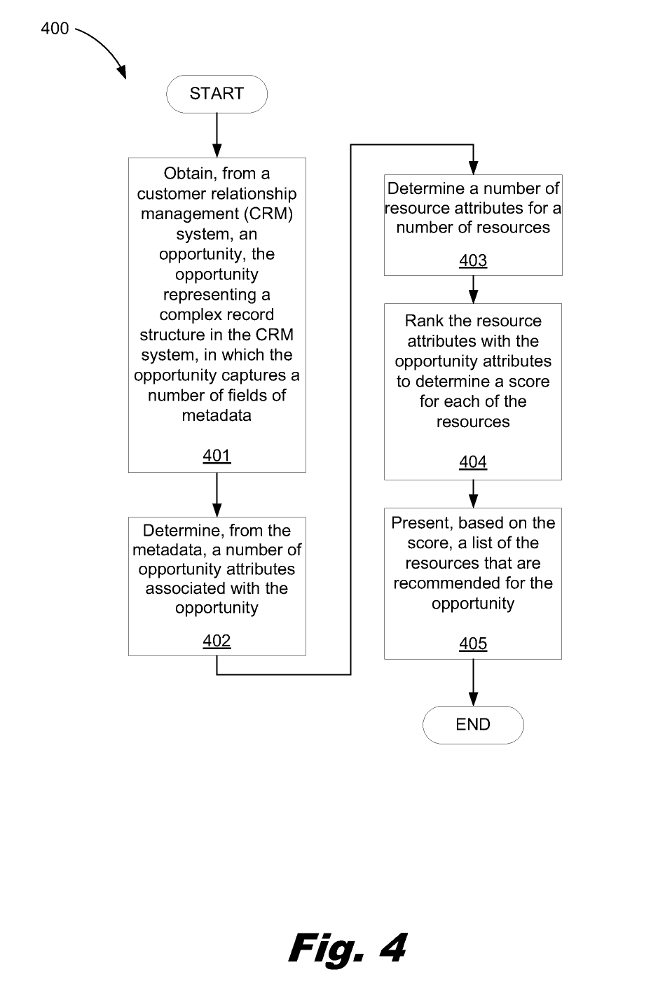

FIG. 4 is a flowchart of an example of a method for matching resources to an opportunity in a CRM system, according to one example of principles described herein. In one example, the method (400) may be executed by the matching system (100) of FIG. 1. In other examples, the method (400) may be executed by other systems (i.e. system 200, system 600, and system 700). In this example, the method (400) includes obtaining (401), from a CRM system, an opportunity, the opportunity representing a complex record structure in the CRM system, in which the opportunity captures a number of fields of metadata, determining (402), from the metadata, a number of opportunity attributes associated with the opportunity, determining (403) a number of resource attributes for a number of resources, ranking (404) the resource attributes with the opportunity attributes to determine a score for each of the resources, and presenting (405), based on the score, a list of the resources that are recommended for the opportunity.

As mentioned above, the method (400) includes obtaining (401), from a CRM system, an opportunity, the opportunity representing a complex record structure in the CRM system, in which the opportunity captures a number of fields of metadata. In one example, an obtaining engine obtains, from the CRM system, an opportunity. In another example, the obtaining engine obtains, from the CRM system, several opportunities.

As mentioned above, the method (400) includes determining (402), from the metadata, a number of opportunity attributes associated with the opportunity. In one example, an opportunity attribute determining engine determines, from the metadata, a number of opportunity attributes associated with the opportunity. In one example, the opportunity attributes comprise a client, a location, an industry, a model of coverage by sales, a corporate structure for one of the opportunities, a sales stage, products, offerings, brands, revenue, client attributes, or combinations thereof.

As mentioned above, the method (400) includes determining (403) a number of resource attributes for a number of resources. In one example, a resource attribute determining engine determines a number of resource attributes for a number of resources. In this example, the resource attributes include an incentive, a territory, an expertise, or combinations thereof.

In one example, the incentive may be defined by the resource's payment system. This may include a direct quota, a shared quota, or no incentive.

In one example, the territory may be an area which the resource covers and defined by a sales model and its elements. For example, the sales model may be a country coverage and the element may include an actual country. Further, the sales model may be dedicated to a client and the element may include a list of clients.

In one example, the expertise may be a profile of the resource area of specialty from a sales perspective. This may include specific products and/or roles for clients.

As mentioned above, the method (400) includes ranking (404) the resource attributes with the opportunity attributes to determine a score for each of the resources. As mentioned above, a score may be a mechanism for ranking resource attributes with the opportunity attributes to determine how well a resources match with an opportunity. Further, a score may be symbolic such as low, medium, or high. As will be describe below, a score that is low indicates that a resource is not a good match with an opportunity. Alternatively, a score that is high indicates that a resource is a good match with an opportunity. Further, a score may be based on a scale, such as 0 to 10. In this example, a score of 0 indicates that a resource is not a good match with an opportunity. Alternatively, a score that is 10 indicates that a resource is a good match with an opportunity. In one example, a ranking engine ranks the resource attributes with the opportunity attributes to determine a score.

In one example, the motivation score determines how incented the resource is to help a client associated with an opportunity. In one example, this may be based on paid customer sales. In one example, the motivation score may be low, medium, or high. In this example, a low motivation score indicates the resource is a non-seller. A medium motivation score indicates the resource is paid based on performance of a group. A high motivation score indicates the resource is paid based on a quota. For example, the resource is paid based on personal sales attainment. Further, the motivation score for the resource may be obtained from a compensation system that is associated with the resource.

In one example, the proximity score determines an affinity to the client from a coverage perspective. In one example, the proximity score may be low, medium, or high. In this example, a low proximity score indicates there is no identified relationship to the customer. A medium proximity score indicates the resource may be assigned to a type of a client based on a region or industry. A high proximity score indicates the resource is assigned to a specific customer.

In one example, the skill score determines how relevant the resource's skills to the opportunity are. For example, the skill score may apply to the resource's specific domain, brands, and knowledge. In one example, the skill score may be low, medium, or high. In this example, a low skill score indicates the resource's skills are not relevant. A medium skill score indicates the resource has some relevance to, for example, a brand level. A high skill score indicates the resource has a specific brand expertise.

As mentioned above, ranking the resource attributes with the opportunity attributes to determine the score further includes determining a threshold for the score. For example, the motivation score, proximity score, and skill score for the resources are to exceed a motivation score of medium, a proximity score of high, and skill score of high if the ranking engine is to rank the resource attributes with opportunity attribute A.

As mentioned above, the method (400) includes presenting (405), based on the score, a list of the resources that are recommended for the opportunity. In one example, the resources may be presented based on the score for each of the resources. For example, if the list of the resources includes resource C and resource B, resource C is presented before resource B if resource C has a higher score than resource B. As mentioned above, the list may be presented to the user via a display of a user device. Such a method and system allows a number of resources to be recommended for an opportunity based on a score. As a result, appropriate resources are recommended for an opportunity.

In one example, the resources that are recommended for the opportunity may have to match a score determined by a user. For example, if the user determines the motivation score is high, the proximity score is high, and the skill score indicates a client representative, resources matching those scores may be presented on the list. Further, the recommendations for the opportunity may be done at a specific product and/or brand level. This technique uses the method (400) to match resources having specific score to an opportunity. For example, a resource having a motivation score of high, a proximity score of medium, and a specialty score matching a specific brand and/or product is matched to the opportunity.

In one example, a less desirable resource may lack a financial incentive, but may have the proper domain expertise. In this example, the method (400) may determine the resource is still a viable candidate. As a result, the resource may be presented on the list.

While this example has been described with reference to the method (400) presenting, based on a score, a list of the resources that are recommended for the opportunity, the method (400) may present, based on a score, a list of the opportunities that are recommended for a resource. As a result, appropriate opportunities may be recommended for a resource.

In addition, the method (400) may extend to special roles such as financing an opportunity. In this example, a series of ranked resources could be provided by leveraging information in a compensation system to determine appropriate global financing tagged resources. In this example, a sales stage could be a critical factor in profiling the opportunity since financing is a relatively late in the cycle addition.

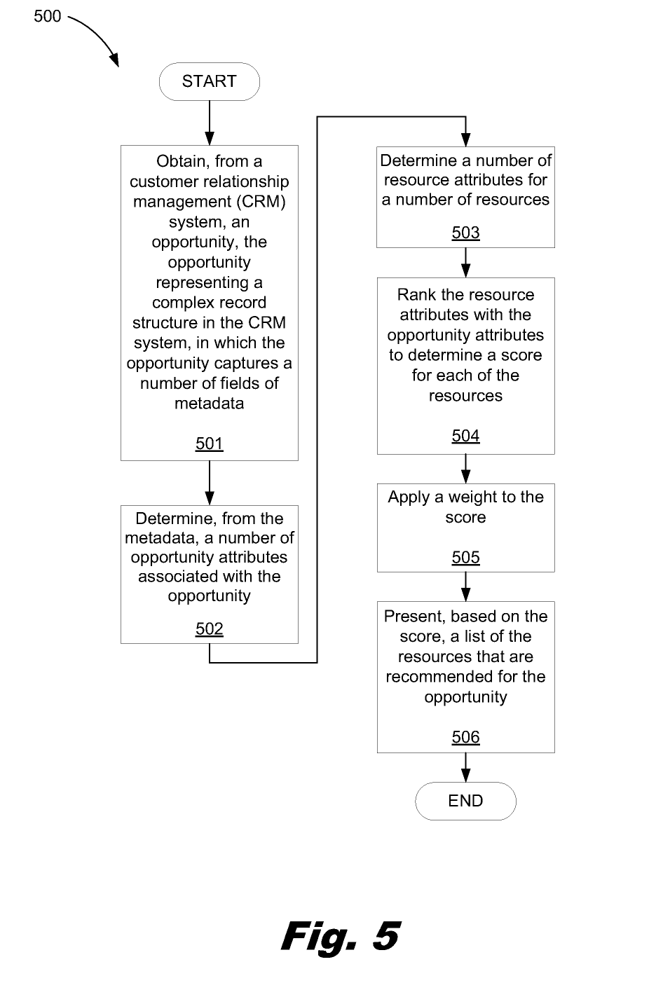

FIG. 5 is a flowchart of an example of a method for matching resources to an opportunity in a CRM system, according to one example of principles described herein. In one example, the method (500) may be executed by the matching system (100) of FIG. 1. In other examples, the method (500) may be executed by other systems (i.e. system 200, system 600, and system 700). In this example, the method (500) includes obtaining (501), from a CRM system, an opportunity, the opportunity representing a complex record structure in the CRM system, in which the opportunity captures a number of fields of metadata, determining (502), from the metadata, a number of opportunity attributes associated with the opportunity, determining (503) a number of resource attributes for a number of resources, ranking (504) the resource attributes with the opportunity attributes to determine a score for each of the resources, applying (505) a weight to the score, and presenting (506), based on the score, a list of the resources that are recommended for the opportunity.

As mentioned above, the method (500) includes applying (505) a weight to the score. In one example, an applying engine applies a weigh to the score. In one example, the applying engine applies a weigh to a motivation score, a proximity score, an expertise score, or combinations thereof. In this example, applying the weigh to the score allows a user to refine the list of the resources that are recommended for the opportunity. For example, if a user is interested in resources with a high motivation score for a given opportunity, the applying engine applies a weigh to the motivation score. As a result, the applying engine may be used to further match resources to an opportunity.

FIG. 6 is a diagram of an example of a matching system, according to the principles described herein. The matching system (600) includes an obtaining engine (602), an opportunity attribute determining engine (604), a resource attribute determining engine (606), a ranking engine (608), and a presenting engine (610). In this example, the matching system (600) also includes an applying engine (612). The engines (602, 604, 606, 608, 610, 612) refer to a combination of hardware and program instructions to perform a designated function. Each of the engines (602, 604, 606, 608, 610, 612) may include a processor and memory. The program instructions are stored in the memory and cause the processor to execute the designated function of the engine.

The obtaining engine (602) obtains, from a CRM system, an opportunity, the opportunity representing a complex record structure in the CRM system, in which the opportunity captures a number of fields of metadata. In one example, the obtaining engine (602) obtains, from a CRM system, several opportunities.

The opportunity attribute determining engine (604) determines, from the metadata, a number of opportunity attributes associated with the opportunity. In one example, the opportunity attributes include a client, a location, an industry, a model of coverage by sales, a corporate structure for one of the opportunities a sales stage, products, offerings, brands, revenue, client attributes, or combinations thereof.

The resource attribute determining engine (606) determines a number of resource attributes for a number of resources. In one example, the resource attributes include an incentive, a territory, an expertise, or combinations thereof.

The ranking engine (608) ranks the resource attributes with the opportunity attributes to determine a score for each of the resources. In one example, the score includes a motivation score, a proximity score, a skill score, or combinations thereof. Further, the ranking engine (608) ranks the resource attributes with the opportunity attributes to determine a score for each of the resources by further determining a threshold for the score.

The presenting engine (610) presents, based on the score, a list of the resources that are recommended for the opportunity. In one example, the presenting engine (610) presents, based on the score, a list of the resources that are recommended for the opportunity via a display of a user device.

The applying engine (612) applies a weight to the score. In one example, an applying engine (612) applies a weigh to a motivation score, a proximity score, an expertise score, or combinations thereof. Further, applying a weigh, via the applying engine (612), to the score allows a user to refine the list of the resources that are recommended for the opportunity.

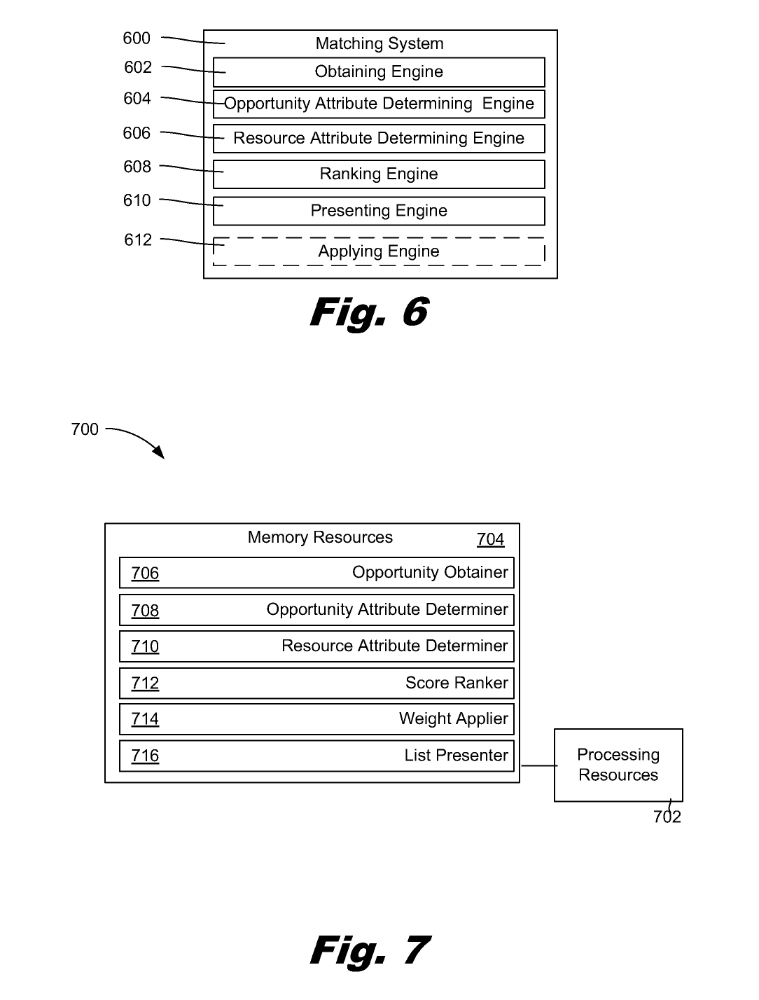

FIG. 7 is a diagram of an example of a matching system, according to the principles described herein. In this example, the matching system (700) includes processing resources (702) that are in communication with memory resources (704). Processing resources (702) include at least one processor and other resources used to process programmed instructions. The memory resources (704) represent generally any memory capable of storing data such as programmed instructions or data structures used by the matching system (700). The programmed instructions shown stored in the memory resources (704) include an opportunity obtainer (706), an opportunity attribute determiner (708), a resource attribute determiner (710), a score ranker (712), a weight applier (714), and a list presenter (716).

The memory resources (704) include a computer readable storage medium that contains computer readable program code to cause tasks to be executed by the processing resources (702). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The opportunity obtainer (706) represents programmed instructions that, when executed, cause the processing resources (702) to obtain, from a CRM system, an opportunity, the opportunity representing a complex record structure in the CRM system, in which the opportunity captures a number of fields of metadata. The opportunity attribute determiner (708) represents programmed instructions that, when executed, cause the processing resources (702) to determine, from the metadata, a number of opportunity attributes associated with the opportunity.

The resource attribute determiner (710) represents programmed instructions that, when executed, cause the processing resources (702) to determine a number of resource attributes for a number of resources. The score ranker (712) represents programmed instructions that, when executed, cause the processing resources (702) to rank the resource attributes with the opportunity attributes to determine a score for each of the resources.

The weight applier (714) represents programmed instructions that, when executed, cause the processing resources (702) to apply a weigh to the score. The list presenter (716) represents programmed instructions that, when executed, cause the processing resources (702) to present, based on the score, a list of the resources that are recommended for the opportunity.

Further, the memory resources (704) may be part of an installation package. In response to installing the installation package, the programmed instructions of the memory resources (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (702) and the memory resources (704) are located within the same physical component, such as a server, or a network component. The memory resources (704) may be part of the physical component's main memory, caches, registers, non-volatile memory, or elsewhere in the physical component's memory hierarchy. Alternatively, the memory resources (704) may be in communication with the processing resources (702) over a network. Further, the data structures, such as the libraries, may be accessed from a remote location over a network connection while the programmed instructions are located locally. Thus, matching system (700) may be implemented on a user device, on a server, on a collection of servers, or combinations thereof.

The matching system (700) of FIG. 7 may be part of a general purpose computer. However, in alternative examples, the matching system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for matching resources to an opportunity in a customer relationship management (CRM) system, the method comprising:
obtaining, from a customer relationship management (CRM) system, an opportunity, the opportunity representing a complex record structure in the CRM system, in which the opportunity captures a number of fields of metadata;
determining, from the metadata, a number of opportunity attributes associated with the opportunity;
determining a number of resource attributes for a number of resources;
ranking the resource attributes with the opportunity attributes to determine a score for each of the resources; and
presenting, based on the score, a list of the resources that are recommended for the opportunity.

2. The method of claim 1, in which the resource attributes comprises an incentive, a territory, an expertise, or combinations thereof.

3. The method of claim 1, in which the opportunity attributes comprises a client, a location, an industry, a model of coverage by sales, a corporate structure for one of the opportunities a sales stage, products, brands, revenue, client attributes, or combinations thereof.

4. The method of claim 1, in which the score comprises a motivation score, a proximity score, a skill score, or combinations thereof for each of the resources.

5. The method of claim 1, in which ranking the resource attributes with the opportunity attributes to determine the score for each of the resources further comprises determining a threshold for the score.

6. The method of claim 1, further comprising applying a weigh to the score.

7. The method of claim 6, in which applying the weigh to the score allows a user to refine the list of the resources that are recommended for the opportunity.
